(19) United States
(12) Patent Application Publication
(10) Pub. No.: US 2006/0266240 A1
(43) Pub. Date: Nov. 30, 2006

(54) 'Four-in-One' Self Inking Stamp

(76) Inventor: Nitesh Ratnakar, Oak Creek, WI (US)

Correspondence Address: NITESH RATNAKAR, ROUTE 3,, BOX 179-A, ELKINS, WV, 26241, US

(21) Appl. No.: 10/908,860

(22) Filed: May 29, 2005

(51) Int. Cl. B41K 1/42

(52) U.S. Cl. 101/333

(57) ABSTRACT

The present invention relates to a ‘four-in-one’ self inking stamp with means to print multiple message sets/drawings from one such stamp. It includes an inner housing; an outer housing operatively associated with and vertically displaceable with respect to the inner housing; an ink pad means for removably supporting an ink pad; spring means compressed between the outer housing and the ink pad means; wherein the spring means holds the outer housing in its upper position; stamp die means for displaceably mounting a ‘stamp die’ within the inner housing; wherein the ‘stamp die’ has means to accommodate up to four ‘stamp plates’; an ‘actuator assembly’ operatively engaged with the ‘stamp die’ wherein the ‘actuator assembly’ has means to bring a desired ‘stamp plate’ in the ‘inking position’; and a turnover means for causing a selected ‘stamp plate’ to turn from ‘inking’ position to ‘printing’ position.

### FIELD OF INVENTION

The present invention relates to self inking stamps; more specifically to a self inking stamp that has means to print multiple message sets/drawings from a single such stamp.

### PRIOR ART

Self inking stamps are known in the prior art for many years. In U.S. Pat. No. 5,517,916 issued on May 21, 1996 Dour et al have described self-inking stamping devices which include a frame, an encasement surrounding the frame and vertically displaceable with respect thereto between upper and lower positions, an ink pad holder supporting an ink pad at the upper end of the frame, a stamp die holder for mounting a stamp die within the frame, a turnover mechanism for operating the stamp die holder between positions in contact with the ink pad and where the stamp die is in a stamping position, and springs affixed to the ink pad holder and normally compressed between the encasement and the ink pad holder so that the ink pad can be removed from the frame without removing the ink pad holder, and the springs hold the encasement in a position from which it can be pressed downwardly against the spring into its stamping position.

In U.S. Pat. No. 5,649,485 issued on Jul. 22, 1997, Dour et al have described self-inking stamp which includes a inner housing having a lower end for contacting a support surface and an upper end, an outer housing operatively associated with and vertically displaceable with respect to the inner housing between upper and lower positions with respect to the inner housing, the outer housing including an upper end, ink pad means for removably supporting an ink pad at the upper end of the inner housing, stamp die means for displaceably mounting a stamp die within the inner housing, turnover means for causing the stamp die means to be displaced between a first position in which the stamp die is in contact with the ink pad and the outer housing is in its upper position with respect to the inner housing, and a second position in which the stamp die is in a stamping position at the support surface when the outer housing is in the lower position with respect to the inner housing, and spring means affixed to the ink pad means and normally compressed between the outer housing and the ink pad means whereby the ink pad can be removed from the inner housing without removing the ink pad means and the spring means holds the outer housing in its upper position from which the outer housing can be pressed downwardly against the spring means relative to the inner housing into the lower position in order to effect stamping therewith.

The self inking stamps have made the use of stamps user friendly and more portable. However, one major disadvantage of the present self inking stamps is that it has means to print only one message set/drawing. In order to print multiple message sets/drawings, the user is required to have multiple self inking stamps. With self-inking stamps this is a great disadvantage because such stamp on the whole is comparatively complex and expensive. It is also problematic when the user is required to carry multiple self inking stamps if he/she wishes to have means to print more than one message set/drawing.

### OBJECTS OF THE INVENTION

Accordingly, the object of the present invention is to provide a self inking stamp wherein means are provided to print more than one message set/drawing from a single such self inking stamp; and wherein means are provided for the user to select the message set/drawing to be printed.

The advantages; and the workings of the ‘four-in-one’ self inking stamp are discussed in details in the description and drawings, which follow. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out one or several purposes of the present invention. It is important, therefore, that the claims be regarded as including such equivalent constructions insofar as they do not depart from the spirit and scope of the present invention. Additional features and advantages of the present invention will be set forth in the description and drawings which follow or may be learned by practice of the invention. Also, the same or similar parts in the various embodiments of the present invention, described hereafter, have been marked identically to simplify the understanding of the said embodiments.

### SUMMARY OF INVENTION

The present invention relates to a self inking stamp, hereby referred to as ‘four-in-one’ self inking stamp, wherein each such stamp has means to print up to four message sets/drawings. The ‘four-in-one’ self inking stamp contains a ‘stamp die’ with four of its surfaces having means to accommodate one ‘stamp plate’ each. Each ‘stamp plate’ has a fixed set of stamp characters (e.g. letters, numerals, etc. representing a message set/drawing) via fixed applications of rubber printing dies. An actuator assembly is provided that enables rotational movement of the ‘stamp die’ along its horizontal axis. Means are provided to move the said actuator assembly both manually and electronically. The actuator assembly provides the user with means to bring a desired surface of the ‘stamp die’ (housing the ‘stamp plate’ with the desired message set/drawing) into the ‘inking position’. A display means is provided to display the message set/drawing selected by the user to be printed. The printing mechanism of the ‘four-in-one’ self inking stamp is similar to that of the self inking stamps currently in use. According to another aspect, the present invention outlines some practical applications of the ‘four-in-one’ self finking stamp, more specifically, its use in the marketing and promotion of pharmaceutical products.

### BRIEF DESCRIPTION OF DRAWINGS

FIG. 1A shows the construction of a self inking stamp presently in use.

FIG. 1B shows the printing mechanism of the present self inking stamps.

FIG. 2A shows the construction of a mechanical ‘four-in-one’ self inking stamp; wherein the actuator assembly is operated by mechanical means.

FIG. 2B (i) shows the construction of the inner housing of the ‘four-in-one’ self inking stamp.

FIG. 2B (ii) shows the connection means between two connecters of the ‘four-in-one’ self inking stamp.

FIG. 2C shows the operation of the actuator assembly of the mechanical ‘four-in-one’ self inking stamp.

FIG. 2D shows the printing mechanism of the mechanical ‘four-in-one’ self inking stamp.

FIG. 3A shows the construction of the electronic ‘four-in-one’ self inking stamp; wherein the actuator assembly is operated by electronic means.

FIG. 3B shows the operation of the actuator assembly of the electronic ‘four-in-one’ self inking stamp.

FIG. 3C shows the printing mechanism of the electronic ‘four-in-one’ self inking stamp.

FIG. 3D is an outside view of the electronic ‘four-in-one’ self inking stamp and illustrates the means to display the message sets/drawings contained in the stamp plates; and the means to select a desired message set/drawing to be printed.

FIG. 4A shows the construction of the ‘stamp die encasing’ with a ‘stamp die’ contained therein; wherein each of the four ‘stamp plates’ contained in ‘stamp die’ is flush with an ‘ink pad’.

FIG. 4B is a view of the ‘stamp die encasing’ wherein the bottom wall of the ‘stamp die encasing’ is in an open position to allow the ‘stamp die’ contained therein to emerge from the said ‘stamp die encasing’.

FIG. 5A shows the construction of an electronic ‘four-in-one’ self inking stamp containing the ‘stamp die encasing’.

FIG. 5B shows the printing mechanism of the electronic ‘four-in-one’ self inking stamp shown in FIG. 5A, wherein the bottom wall of the ‘inking pad encasing’ is in an open position and the ‘stamp die’ is outside of the said ‘stamp die encasing’; and wherein the ‘stamp die’ is making an imprint on a printing surface.

FIG. 6 shows the construction of a regular stamp containing a ‘stamp die’ with means to hold four ‘stamp plates’; and an actuator assembly to rotate the said ‘stamp die’ along its horizontal axis.

FIG. 7(i) shows an octagonal ‘stamp die’ with means to hold up to eight ‘stamp plates’.

FIG. 7(ii) shows a hexagonal ‘stamp die’ with means to hold up to six ‘stamp plates’.

### DETAIL DESCRIPTION OF DRAWINGS

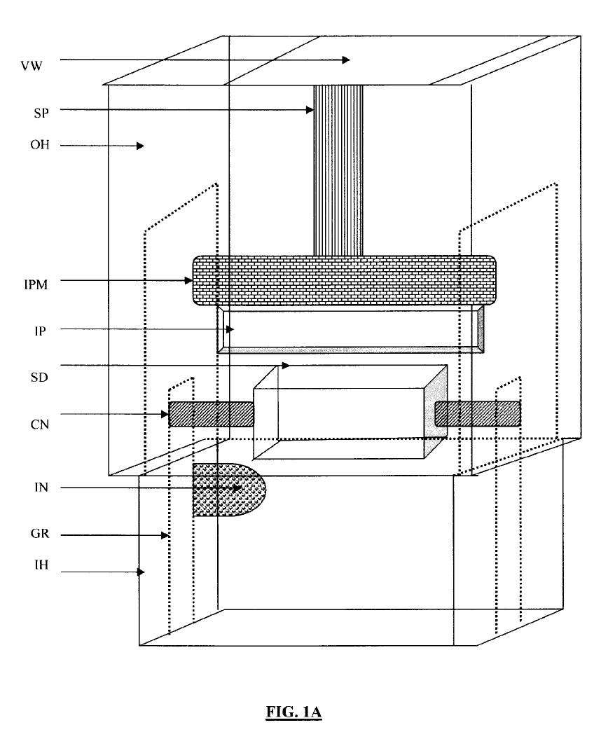

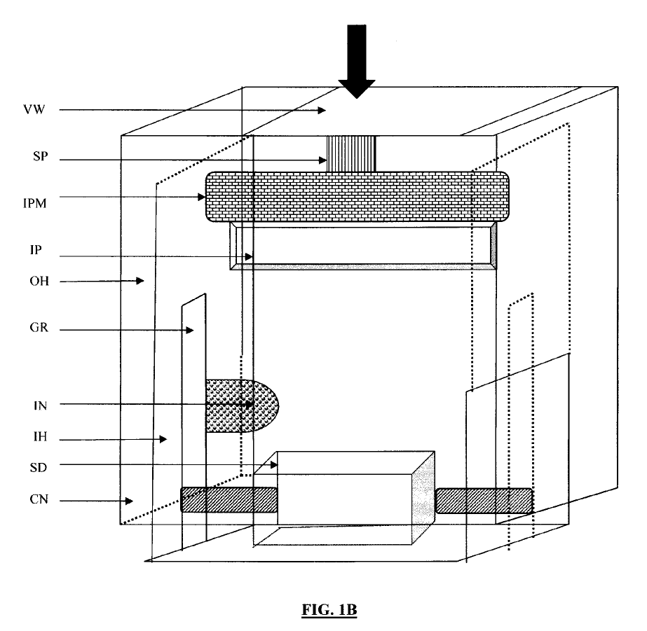

FIGS. 1A & 1B show the construction and working of a conventional self inking stamp. A conventional self inking stamp includes an ‘inner housing’ (IH, the supporting frame) having a lower end for contacting a printing surface and an upper end; an ‘outer housing’ (OH, the operating frame) operatively associated with and vertically displaceable with respect to the ‘inner housing’ (IH) between upper and lower positions with respect to the ‘inner housing’ (IH), ‘ink pad means’ (IPM) for removably supporting an ‘ink pad’ (IP) at the upper end of the ‘inner housing’ (IH), stamp die means for mounting a ‘stamp die’ (SD) within the ‘inner housing’ (IH), but attached to the ‘outer housing’ (OH), turnover means comprising of an ‘inverter’ (IN) affixed to the ‘inner housing’ (IH) for causing the ‘stamp die’ (SD) to be displaced between a first position in which the ‘stamp die’ (SD) is in contact with the ‘ink pad’ (IP) in its upper position with respect to the inner housing (the ‘inking position’), and a second position in which the ‘stamp die’ (SD) is in a ‘printing position’ at a printing surface when the ‘outer housing’ (OH) is in the lower position with respect to the ‘inner housing’ (IH), and spring (SP) means affixed to the ‘ink pad means’ (IPM) (IPM) and normally compressed between the ‘outer housing’ (OH) and the ‘ink pad means’ (IPM) whereby the ‘ink pad’ (IP) can be removed from the ‘inner housing’ (IH) without removing the ‘ink pad means’ (IPM) and the spring (SP) holds the ‘outer housing’ (OH) in its upper position from which the ‘outer housing’ (OH) can be pressed downwardly against the spring (SP) means relative to the ‘inner housing’ (IH) into the lower position in order to effect stamping therewith. Once stamping is achieved, the ‘outer housing’ (OH) is pushed vertically up relative to the ‘inner housing’ (IH) by spring (SP) means to bring the self inking stamp back to the resting position.

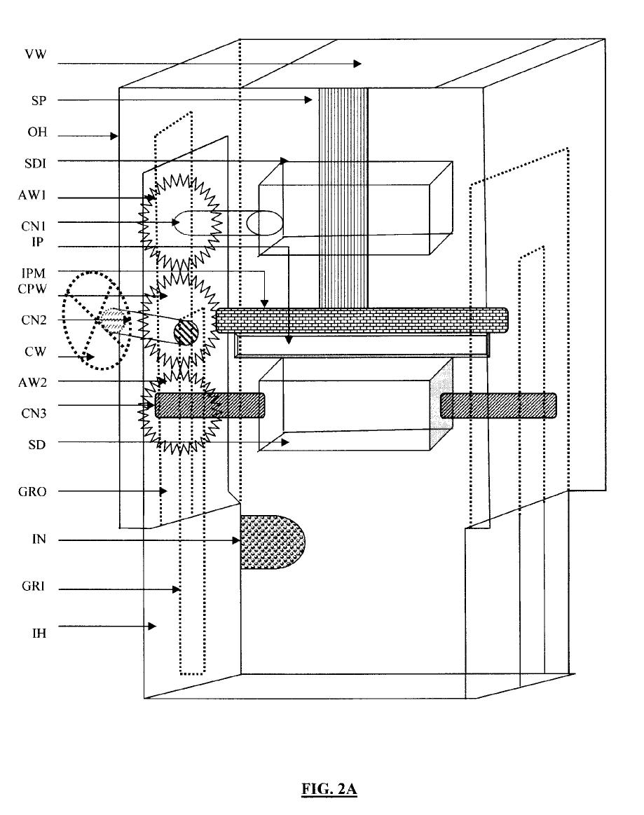

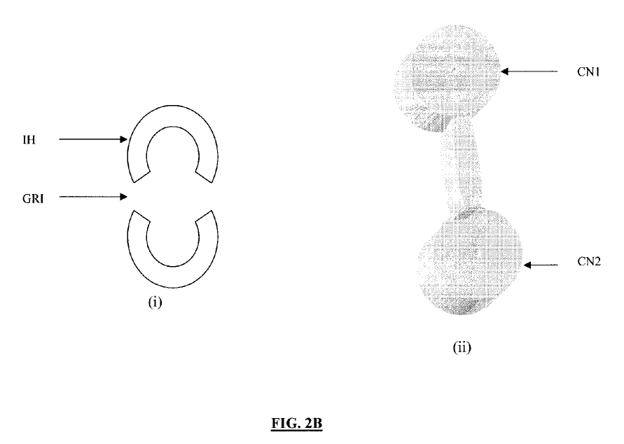

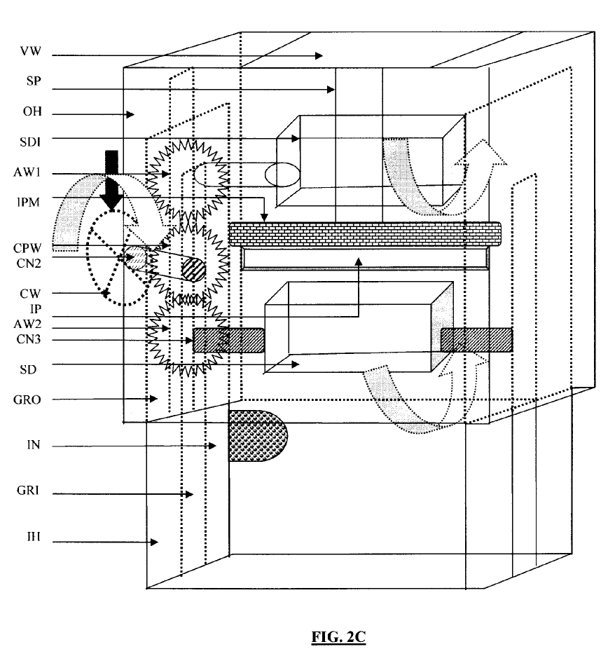

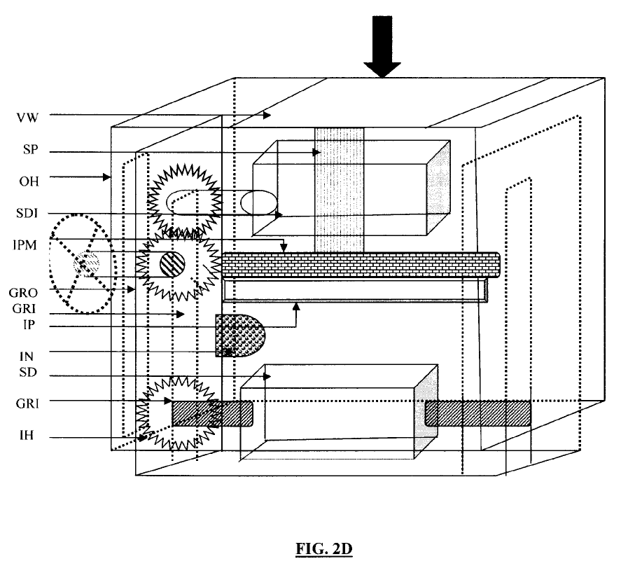

FIGS. 2A-2D shows the construction and operation of the manual version of the ‘four-in-one’ self inking stamp. The general construction and the printing mechanism of the manual ‘four-in-one’ self inking stamp is similar to a conventional self inking stamp as described in paragraph 27. The manual ‘four-in-one’ self inking stamp however has additional features and modifications to achieve the objectives of the present invention. The construction of the manual ‘four-in-one’ self inking stamp is shown in FIG. 2A. The ‘stamp die’ (SD) is rectangular or square block containing four surfaces, each with means to accommodate one ‘stamp plate’; each ‘stamp plate’ containing an assortment of stamp characters representing one message set/drawing; and fixedly affixed to the said ‘stamp die’ (SD). The ‘stamp die’ (SD) is attached to the ‘outer housing’ (OH) by means of a ‘connecter’ (CN3). Means are provided, in the form of an actuator assembly, to rotationally move the ‘stamp die’ (SD) in different directions along its horizontal axis. This is helpful to the user to position a desired surface of the ‘stamp die’ (SD) (housing a ‘stamp plate’ containing the desired message set/drawing) in the ‘inking position’. An ‘indicator stamp die’ (SDI), with four ‘indicator stamp plates’, is provided; each ‘indicator stamp plate’ containing a message set/drawing representative of the message set/drawing contained in the corresponding ‘stamp plate’ housed on the ‘stamp die’ (SD). The ‘indicator stamp die’ (SDI) is fixedly attached to the ‘inner housing’ (IH) and positioned above the ‘ink pad means’ (IPM). The ‘indicator stamp die’ (SDI) is aligned with the ‘view window’ to enable the display of the ‘indicator stamp plate’ containing the message set/drawing selected by the user. The ‘inner housing’ (IH) is a folded structure, as shown in its cross sectional view shown in FIG. 2B (i). The actuator assembly is located in between the said folds of the ‘inner housing’ (IH). The actuator assembly comprises of 1) two ‘actuating wheels’ (AW1 & AW2) located inside the inner housing; one connected to the ‘stamp die’ (SD) by means of connector (CN3) and the other to the ‘indicator stamp die’ (SDI) by means of connector (CN1); 2) a ‘coupling wheel’ (CPW) located inside the inner housing and coupled to the ‘actuating wheels’ (AW1 & AW2); and to the ‘control wheel’ (CW) by means of connector (CN2), the said ‘control wheel’ (CW) being outside of the ‘outer housing’ (OH). The ‘control wheel’ (CW) provides the user with means to actuate the rotation of the ‘stamp die’ (SD) and ‘indicator stamp die’ (SDI). A groove (GRI) is provided on the ‘inner housing’ (IH) to enable vertical movement of the ‘connecter’ (CN3); and consequently of the ‘stamp die’ (SD); when the ‘outer housing’ (OH) is moved vertically relative to the ‘inner housing’ (IH). A groove (GRO) is provided on the ‘outer housing’ (OH) to accommodate the connector (CN2) during the vertical movement of the said ‘outer housing’ (OH). The connectors (CN1 & CN2) are fixedly connected to each other by mechanical means to enable synchronous vertical movement of the said connectors (CN1 & CN2), as shown in FIG. 2B(ii).

FIG. 2C illustrates the operation of the actuator assembly of the manual ‘four-in-one’ self inking stamp. It is evident from FIG. 2C that in the resting position, the ‘stamp die’ (SD) lies in close proximity to the ‘ink pad’ (IP) to enable soaking of the ‘stamp plate’ in the ‘inking position’. To enable rotation of the ‘stamp die’ (SD) along its horizontal axis, the ‘stamp die’ (SD) will need to be levered down from the ‘ink pad’ (IP). To achieve this, means are provided to move the entire actuator assembly downwards using the ‘control wheel’ (CW). This is made possible by 1) a vertical groove (GRO & GRI) on the ‘outer housing’ (OH) and ‘inner housing’ (IH) respectively, that enables vertical movement of the connector (CN2) connecting the ‘control wheel’ (CW) to the ‘coupling wheel’ (CPW); and 2) fixedly attaching the connector (CN1) to connector (CN2) by mechanical means, as shown in FIG. 2B (ii), whereby both connectors move synchronously. To actuate the rotation of the ‘stamp die’ (SD), the ‘control wheel’ (CW) is pushed down along the vertical grooves (GRO & GRI) on the outer and inner housing respectively, which brings the actuator assembly to an active position, as shown in FIG. 2C. This downward movement of the actuator assembly separates the ‘stamp die’ (SD) from the ‘ink pad’ (IP) and provides room for rotation of the said ‘stamp die’ (SD). Care is taken to provide enough space between the ‘indicator stamp die’ (SDI) and the ‘ink pad means’ (IPM) to enable rotation of the ‘indicator stamp die’ (SDI) when the actuator assembly is in the active position. Thereafter, the ‘control wheel’ (CW) it is turned clock wise or counter clock wise to move the ‘stamp die’ (SD) and the ‘indicator stamp die’ (SDI). After the desired surface of the ‘stamp die’ (SD) is brought into the ‘inking position’ the ‘control wheel’ (CW) is pulled back up to the resting position. The rotation of the ‘control wheel’ (CW) actuates the rotation of the ‘coupling wheel’ (CPW); which in turn actuates the rotation of the ‘actuating wheels’ (AW1 & AW2); which in turn actuates the rotation of the ‘stamp die’ (SD) and the ‘indicator stamp die’ (SDI). The direction of the rotation of the two ‘actuating wheels’ in response to the rotation of the ‘coupling wheel’ (CPW) is counter directional; i.e. the ‘actuating wheels (AW1 & AW2) rotate in a direction opposite to that of the ‘coupling wheel’ (CPW). In the illustrated example shown in FIG. 2C, clock wise rotation of the ‘control wheel’ results in clock wise rotation of the ‘coupling wheel’ (CPW); which is turn results in counter clock wise rotation of the ‘actuating wheels’ (AW1 & AW2) and hence of the ‘stamp die’ (SD) and the ‘indicator stamp die’ (SDI). Hence, it is important that the ‘indicator stamp plates’ are accordingly matched to their corresponding ‘stamp plates’ in order to correctly display the message set/drawing contained in the ‘stamp plate’ in the inking position.

The printing mechanism of the manual ‘four-in-one’ self inking stamp is shown in FIG. 2D. The general principle of the printing mechanism of the ‘four-in-one’ self inking stamp is similar to that of the conventional self inking stamps as described previously. Downward pressure is applied to the ‘outer housing’ (OH), sliding it vertically over the ‘inner housing’ (IH). The ‘stamp die’ (SD) and the ‘actuating wheel’ (AW2) move synchronously with the ‘outer housing’ (OH) by virtue of their fixed attachment to the ‘outer housing’ (OH) by means of the ‘connecter’ (CN3). Other parts of the ‘four-in-one’ self inking stamp, by virtue of their fixed attachment to the ‘inner housing’ (IH), do not move with the downward movement of the ‘outer housing’ (OH). A groove (GRO) is provided on the ‘outer housing’ (OH) to accommodate the ‘connector’ (CN2) during the vertical movement of the ‘outer housing’ (OH). The ‘stamp die’ (SD) is inverted 180° by means of an ‘inverter’ (IN) attached to the ‘inner housing’ (IH); and the ‘stamp plate’ previously in the ‘inking position’ is flipped to the ‘printing position’. Further pressure on the ‘outer housing’ (OH) brings the said ‘stamp plate’ in contact with a printing surface, thereby imprinting the message set/drawing contained therein. When the pressure on the ‘outer housing’ (OH) is relieved, the spring (SP) brings the ‘four-in-one’ self inking stamp back to the resting position, as shown in FIG. 2A.

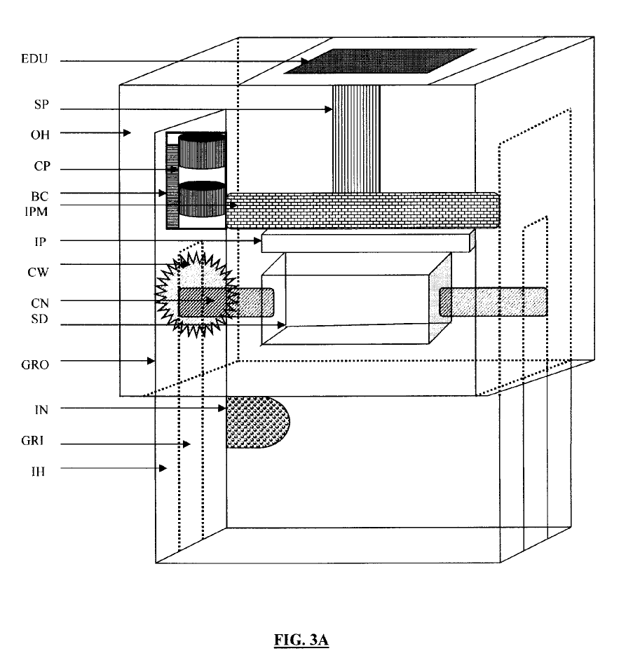

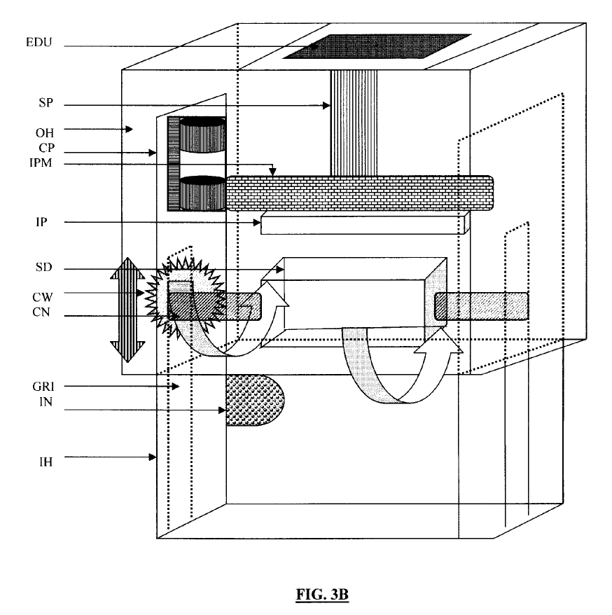

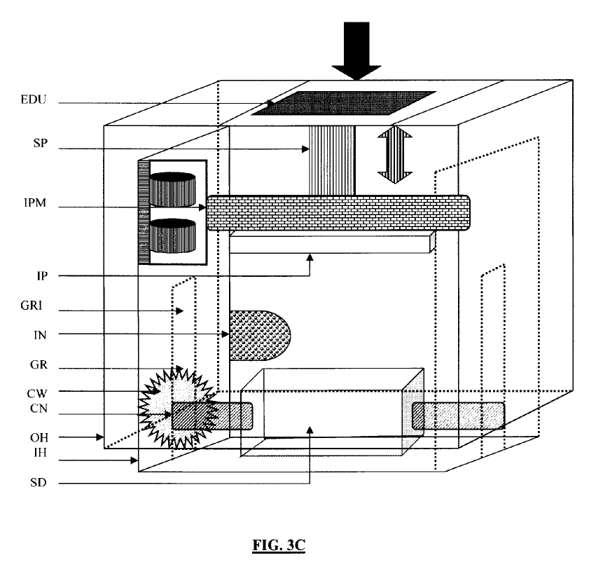

Now let us turn our attention to the electronic version of the ‘four-in-one’ self inking stamp, the construction and operation of which is shown in FIGS. 3A, 3B, 3C & 3D. Again, the general construction and printing mechanism of the electronic ‘four-in-one’ self inking stamp is similar to that of the conventional self inking stamps discussed previously. However, the electronic ‘four-in-one’ self inking stamp has additional features and modifications, described hereafter, to achieve the objectives of the present invention. The actuator assembly comprises of a motorized ‘control wheel’ (CW); to which the ‘stamp die’ (SD) is connected by a ‘connector’ (CN). The motorized ‘control wheel’ (CW) is located inside the ‘inner housing’ (IH). The inner housing is similar in construction to that of the manual ‘four-in-one’ self inking stamp, as shown in FIG. 2B (i), wherein it is a folded structure with a groove (GRI). The groove (GRI) is provided to accommodate the connector (CN) during vertical movement of the ‘outer housing’ (OH) over the ‘inner housing’ (IH). The ‘connecter’ (CN) also attaches the ‘stamp die’ (SD) and the ‘control wheel’ (CW) fixedly to the ‘outer housing’ (OH). A processor (CP) is provided, which is programmed with means to control the rotation of the motorized ‘control wheel’ (CW); and consequently of the ‘stamp die’ (SD). The processor (CP) is located in the ‘inner housing’ (IH). The ‘control wheel’ (CW) is powered by batteries, for which a battery compartment (BC) is provided in of the ‘inner housing’ (IH). Four ‘control switches’ (CS) are provided externally on the upper part of the outer housing, as shown in FIG. 3D. Each ‘control switch’ (CS) represents a ‘stamp plate’; and controls the rotation of the ‘stamp die’ (SD) in a way so as to bring the corresponding ‘stamp plate’ into the ‘inking position’. This is helpful to the user in bringing a desired ‘stamp plate’ in the ‘inking position’. The imprinted message set/drawing on each of the four ‘stamp plate’ is prominently displayed adjacent to its corresponding ‘control switch’ (CS), as shown in FIG. 3D. The imprinted message set/drawing on each ‘stamp plate’ is entered into the processor (CP). The electronic ‘four-in-one’ self inking stamp has an ‘electronic display unit’ (EDU) located on the top surface of the ‘outer housing’ (OH). The processor (CP) regulates the display of message on the ‘electronic display unit’ (EDU); whereby the message set/drawing contained in the ‘stamp plate’ in the ‘inking position’ is displayed. The ‘electronic display unit’ (EDU) is helpful in informing the user of the message set/drawing chosen to be printed. ‘Ink pad means’ (IPM), fixedly attached to the ‘inner housing’ (IH), contains an ‘ink pad’ (IP). A spring (SP) is provided between the ‘ink pad means’ (IPM) and the top of the ‘outer housing’ (OH).

FIG. 3B shows the rotation means of the ‘stamp die’ (SD) of the electronic ‘four-in-one’ self inking stamp. To actuate the rotation of the ‘stamp die’ (SD), the ‘control wheel’ (CW) is activated using one of the ‘control switches’. Means are provided to lever down the ‘control wheel’ (CW) from the ‘ink pad’ (IP) upon activation of a ‘control switch’ (CS), wherein enough space is made available between the ‘stamp die’ (SD) and the ‘ink pad’ (IP) to enable free rotation of the said ‘stamp die’ (SD). The motor of the ‘control wheel’ (CW) then turns in a clock wise or counter clock wise fashion to bring the ‘stamp pad’ corresponding to the ‘control switch’ (CS) to the ‘inking position’. The printing mechanism of the electronic ‘four-in-one’ self inking stamp is shown in FIG. 3C. The ‘outer housing’ (OH) is pushed down vertically, sliding it over the ‘inner housing’ (IH). The ‘control wheel’ (CW) and the ‘stamp die’ (SD) move downward synchronously with the ‘outer housing’ (OH) by virtue their fixed attachment to the ‘outer housing’ (OH) by means of the connector (CN). The ‘stamp die’ (SD) is inverted 180° by the ‘inverter’ (IN); whereby the ‘stamp plate’ previously in the ‘inking position’ is turned to the ‘printing position’. Further pressure on the outer housing brings the said ‘stamp plate’ in contact with a printing surface, thereby printing the message set/drawing contained therein. When the pressure on the outer housing is relieved, the spring (SP) brings the electronic ‘four-in-one’ self inking stamp back to the resting position.

To make the operation of the electronic ‘four-in-one’ self inking stamp more user friendly, another modification is suggested. A default ‘stamp plate’ information is entered into the processor (CP); and the processor (CP) is programmed to bring the said ‘stamp plate’ into the ‘inking position’ after the lapse of a preset time period. The ‘stamp plate’ containing the most frequently used message set/drawing by a user is chosen to be the default. This ensures that the ‘stamp plate’ containing the most frequently used message set/drawing is kept in the ‘inking position’ at most times; ready to print the message set/drawing contained therein, without the need for the user to make any adjustments.

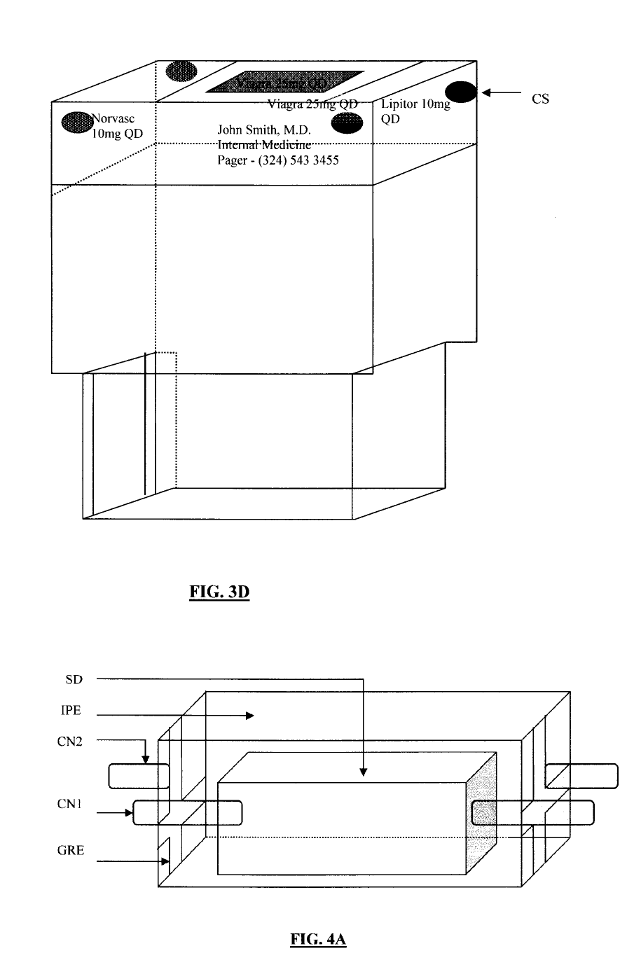

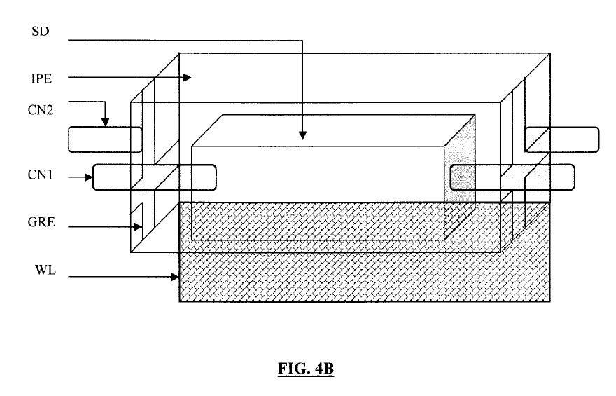

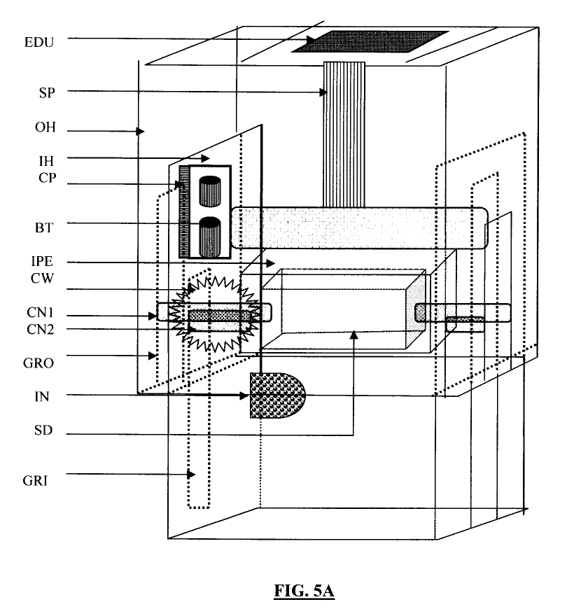

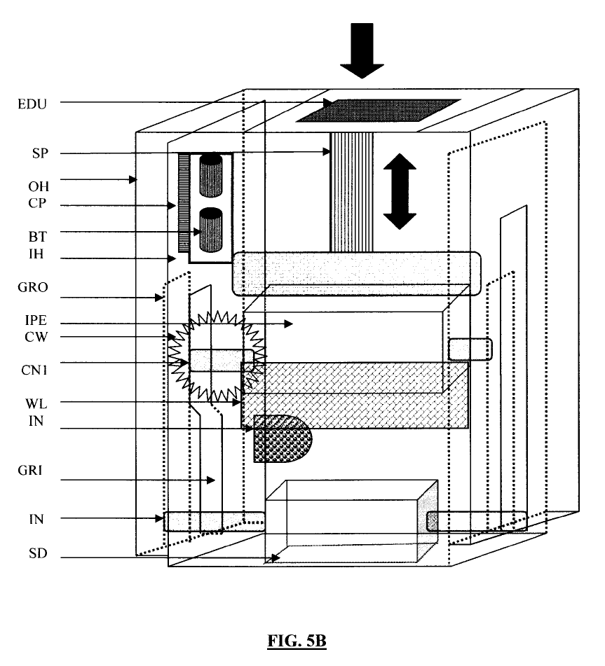

Generally speaking, the quality of the print of a self inking stamp depends on 1) the quality and precision of the stamp characters affixed on the ‘stamp plate’; and 2) the duration of contact between the ‘stamp plate’ and the ‘ink pad’ (IP). In the conventional self inking stamps, the ‘stamp plate’ rests in flush with the ‘ink pad’ (IP) at all times in the resting position. The same can be achieved with the ‘four-in-one’ self inking stamps. To achieve this, the ‘stamp die’ (SD) is encased in a rectangular/square ‘ink pad encasing’ (IPE) as shown in FIG. 4A. The said ‘ink pad encasing’ (IPE) is lined with ‘ink pads’ on its inner surfaces that lie opposite to the ‘stamp plates’ of the ‘stamp die’ (SD). The walls (WL) of the ‘ink pad encasing’ (IPE) are retractable as shown in FIG. 4B. Perpendicular grooves (GRE) are provided on the side walls (WL) of the ‘ink pad encasing’ (IPE) to enable the ‘stamp die’ (SD) to exit and enter the ‘ink pad encasing’ (IPE) from all directions. The construction of a ‘four-in-one’ self inking stamp encompassing the ‘ink pad encasing’ (IPE) is shown in FIG. 5A, which is similar to that of the electronic ‘four-in-one’ self inking stamp shown in FIGS. 4A-4C. However, means are provided to accommodate the ‘ink pad encasing’ (IPE) with the ‘stamp die’ (SD) contained therein. The ‘ink pad encasing’ (IPE) is attached to a motorized ‘control wheel’ (CW) by means of the connecter (CN2). The ‘stamp die’ (SD) is attached fixedly to the ‘outer housing’ (OH) by means of the connecter (CN1). Grooves (GR) are provided in the ‘inner housing’ (IH) to enable the vertical movement of the connectors (CN1 & CN2). The operation and printing mechanism of such a ‘four-in-one’ stamp is shown in FIG. 5B, which is quite similar to that of the electronic ‘four-in-one’ self finking stamp’ as shown in FIGS. 4A-4C. Activation of a ‘control switch’ (CS) results in the rotation of the ‘control wheel’ (CW); which in turn results in the rotation of the ‘ink pad encasing’ (IPE) and the ‘stamp die’ (SD) contained therein; which provides means to position a desired ‘stamp plate’ in the inking position. Means are provided for the downward facing wall (WL) of the ‘ink pad encasing’ (IPE) to open when downward pressure is applied to the ‘outer housing’ (OH). The downward pressure on the ‘outer housing’ (OH) is transmitted to the ‘stamp die’ (SD) by virtue of its fixed attachment to the ‘outer housing’ (OH) by means of the connector (CN1). The pressure on the ‘stamp die’ (SD) pushes open the downward facing wall (WL) of the ‘ink pad encasing’ (IPE). This helps the ‘stamp die’ (SD) to emerge from the ‘ink pad encasing’ (IPE). Thereafter, the ‘stamp die’ is turned 180° by means of an inverter (IN), whereby the surface of the ‘stamp die’ previously in the ‘inking position’ is turned into the ‘printing position’. Further pressure on the ‘outer housing’ (OH) brings the ‘stamp die’ in contact with a printing surface, where after the ‘stamp plate’ in the inking position is printed. When the ‘stamp die’ (SD) reenters the ‘ink pad encasing’ (IPE), the downward facing wall (WL) of the ‘ink pad encasing’ (IPE) closes. This arrangement ensures that the print from all four ‘stamp plates’ of the ‘four-in-one’ self inking stamp is of optimal quality. On the same note however, this practice may not be required with; 1) the modern ‘ink pads’ which are more porous and have improved ink retention; 2) improved quality of the modern ink; and 3) improved quality of the stamping characters affixed on the ‘stamp plate’ which have improved ink retention capability. Because of the aforementioned improvements, only short duration contact between the ‘stamp plate’ and the ‘ink pad’ may be required to give a high quality print.

In the preferred embodiments so far, the concept of ‘four-in-one’ stamps is discussed in context of the self inking stamps. However, the concept of ‘four-in-one’ stamp can also be applied to the old fashioned regular stamps. This is illustrated in FIG. 6. A ‘stamp die’ (SD) with means to accommodate up to four ‘stamp plates’ is provided. A ‘holder’ (HL)’ with a ‘control wheel’ (CW) is provided. A ‘handle’ (HN) is attached to the ‘holder’ (HL) to provide grip means for the user. The ‘stamp die’ (SD) is attached to the ‘holder’ (HL)’ and to the ‘control wheel’ (CW) by a ‘connector’ (CN). The ‘control wheel’ (CW) is used to rotate the ‘stamp die’ (SD) along its horizontal axis in order to bring a said ‘stamp plate’ containing the desired message set/drawing into the ‘printing position’. Care is taken to provide enough space between the ‘stamp die’ (SD) and the ‘holder’ (HL) to enable rotation of the ‘stamp die’ (SD). Once the desired ‘stamp plate’ is brought into the ‘printing position’, it is soaked with ink using an external ink pad; subsequent to which the message set/drawing contained therein is printed on a printing surface.

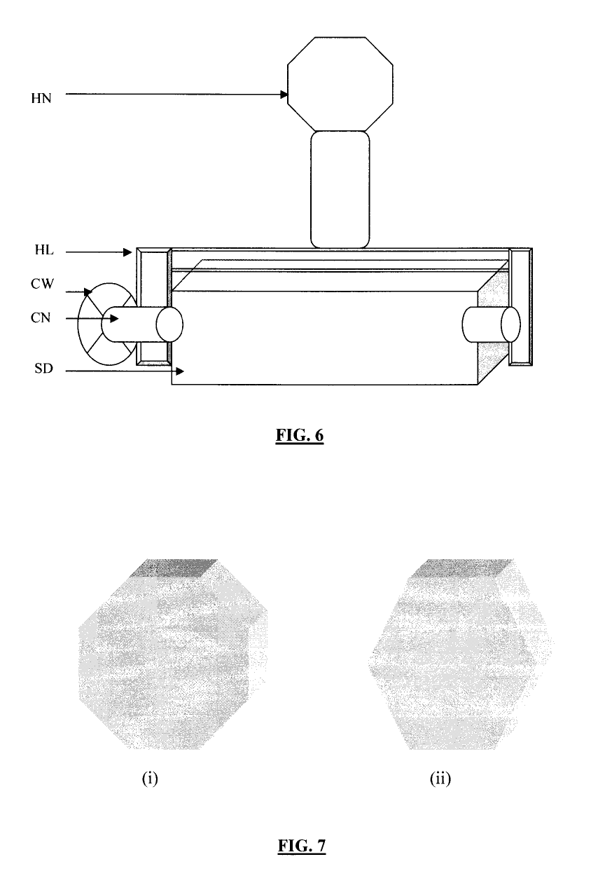

The ‘four-in-one’ self inking stamp is capable of other embodiments without compromising the basic principles and spirit of the present invention. Some possible variations that can be made to the ‘four-in-one’ self inking stamp are; 1) the shape of the stamp die can be altered to accommodate a different number of ‘stamp dies’, as shown in FIG. 7, wherein an octagonal (FIG. 7(i)) and a hexagonal (FIG. 7(ii)) stamp die is shown that has means to accommodate eight and sex ‘stamp dies’ respectively; 2) a different configuration of the actuator assembly can be used to achieve the same end result; 3) the display means for the message set/drawing on the stamp plate can be modified or changed. The list of possible changes outlined above, are by no means all inclusive.

Now we will discuss some applications of the ‘four-in-one’ self inking stamps; including its use in the promotion of a product, particularly pharmaceutical products. It is common practice in the pharmaceutical industry to give out self inking stamps to physicians and other medical providers. Usually such self inking stamps contain prescription templates of a drug being promoted by the said pharmaceutical company. The goal of this practice is to make the process of prescribing the said drug easier by enabling physicians and other medical providers easily print the prescription template of the said drug using the self inking stamp, instead of writing it out. However, this method of promoting pharmaceutical products does not usually work because; 1) the said self inking stamps are not helpful to physicians and medical providers as it does not contain any information pertinent to their practice, and do not add any value to their practice of medicine; 2) it is common for a physician to have multiple such self inking stamps, each containing the prescription template of a different drug. It is difficult and cumbersome to carry multiple self inking stamps, especially during the process of seeing patients from one room to another. The ‘four-in-one’ self inking stamp will be of tremendous benefit to the pharmaceutical companies in promoting pharmaceutical products. It enables a pharmaceutical company to accommodate prescription templates for multiple drugs in one self inking stamp. It also enables a pharmaceutical company to combine drug information with information of value to the medical practice, in one easy to carry self inking stamp. For example, Pfizer makes the drug “Lipitor” in three different strengths—10 mg, 20 mg and 40 mg. Also, it is common practice for physicians to carry a self inking stamp with their identification information which they print after writing their orders and notes; like “John Smith, M.D., Internal Medicine, Pager—(324) 543 3455”. These four message sets (“Lipitor” in three strengths and physician's identification information) can be printed using one ‘four-in-one’ self inking stamp. We believe that it will significantly help in promoting a pharmaceutical product by 1) providing an incentive to physicians and other medical providers to carry the said ‘four-in-one’ self inking stamp as it contains information of personal benefit to the provider; and 2) making the process prescribing a particular medicine; in up to three different strengths/formulations; easy, quick and effortless. More importantly, the ‘four-in-one’ self inking stamp will also help in reducing prescription errors as the prescribing information for the promoted drug is pre printed. Similarly, other combinations of drug information and information useful to the medical provider can be used to promote a company's products. According to another example, the pharmaceutical company Pfizer makes the medicines “Lipitor”, “Norvasc” and “Viagra”. As shown in FIG. 3D, a ‘four-in-one’ self inking stamp is provided with means to print information about these three medicines manufactured by Pfizer; along with the prescribing physician's identification information. This could be a very efficient and cost effective way to market and promote multiple pharmaceutical products using a single ‘four-in-one’ self inking stamp. The prescriptions written by the use of said ‘four-in-one’ self inking stamps can be tracked using one of many available methods, including prescription registries. Alternatively, bar code means can be added to each prescription template to track the sales thus generated. This information can be used to pay sales commission in an innovative way, whereby sales commission is paid in proportion of the sales generated by the use of said ‘four-in-one’ self inking stamps.

The use of the “four-in-one” self inking stamp can also be used in other ways to boost sales of pharmaceutical products. It is a well known fact that prescribing pattern for medicines varies from one physician to another. For example, some physicians like to prescribe “Norvasc” for hypertension whereas others like to prescribe “Metoprolol”. According to another method of improving sales of pharmaceutical products, physicians and other medical providers are asked for the most commonly medicines prescribed by them; or such information is gathered by prescription registries. Thereafter, a customized ‘four-in-one’ self inking stamp is made for each provider; each such customized ‘four-in-one’ self inking stamp containing prescription templates for up to three medicines most commonly prescribed by the said medical provider; and one message set containing information of personal interest to the said provider, such as his/her identification information. The sales generated from use of such customized ‘four-in-one’ self inking stamps is tracked using one of many available methods like prescription registries. Alternatively, bar code means can be added to each prescription template to track the sales thus generated. This information can be useful in determination of sales commission; whereby sales commission is paid in proportion to the sales generated by the use of such customized ‘four-in-one’ self inking stamps. It is very likely that this practice will decrease the manpower required to promote a drug; decrease the need for direct consumer marketing; while at the same time increasing the sales volume. These outcomes will eventually decrease drug prices, decrease health care costs and make essential drugs affordable to patients, especially to seniors and poor patients.

What is claimed is:

1. A stamp comprising of a stamp die with means to hold more than one stamp plate; wherein one or more of stamp plates house one or more stamp characters.

2. The stamp of claim 1 wherein; means are provided, in the form of an actuator assembly, for the user to select the stamp plate to be printed.

3. The stamp of claim 2; wherein the actuator assembly comprises of a set interlocked wheels.

4. The stamp of claim 2; wherein means are provided to operate the actuator assembly manually.

5. The stamp of claim 2 wherein; the actuator assembly comprises of a motorized wheel.

6. The stamp of claim 2; wherein means are provided to operate the actuator assembly electronically.

7. The stamp of claim 1 wherein; means are provided to display the message contained in the stamp character set affixed to the stamp plates.

8. A method of promoting the sale of a product, comprising of a stamp of claim 1; wherein one or more stamp plates contain information about the said product.

9. The method of promoting the sale of a product of claim 8 wherein; one or more stamp plate contains information of interest to the party promoting the said product.

10. The method of promoting the sale of a product of claim 8 wherein; means are provided to track the sale of the said product, resulting from the use of the said stamp.

11. A method of determining sales commission on a product wherein; commission is paid according the sale of the said product generated by the use of a stamp; wherein the stamp characters contained in the said stamp contain information about the said product.

12. The method of determining sales commission on a product of claim 11; wherein means are provided to track the sale generated as a result of the use of the said stamp.

13. The means to track the sale of a product generated as a result of the use of a stamp of claim 12; wherein the said tracking means comprises of a set of stamp characters representing bar code means affixed to one or more stamp plates.
